(19) United States
(12) Patent Application Publication
(10) Pub. No.: US 2019/0180723 A1
(43) Pub. Date: Jun. 13, 2019

(54) Optimized Rendering with Eye Tracking in a Head-Mounted Display

(71) Applicant: Universität Des Saarlandes, Saarbrücken (DE)

(72) Inventors: Daniel Pohl, Großenseebach (DE); Xucong Zhang, Saarbrücken (DE); Andreas Bulling, Saarbrücken (DE)

(73) Assignee: Universität Des Saarlandes, Saarbrücken (DE)

(21) Appl. No.: 16/321,922

(22) PCT Filed: Aug. 1, 2017
(86) PCT No.: PCT/EP2017/069475

§ 371 Date: Jan. 30, 2019

(30) Foreign Application Priority Data
Aug. 1, 2016 (EP) 16182250.7

(51) Int. Cl. G09G 5/391; G06F 3/01; G06F 3/02

(52) U.S. Cl. CPC G09G 5/391; G06F 3/013; G09G 2340/0407; G09G 2354/00; G06F 3/02

(57) ABSTRACT

The invention is directed to a method and a device for controlling images in a head mounted display equipped with an eye tracker and worn by a user, comprising the following steps: detecting, with the eye-tracker, an eye gaze of at least one of the eyes of the user; controlling the images depending on the detected eye gaze; wherein the step of controlling the images comprises not rendering or not updating pixels (22) of the images that are not visible by the user at the detected eye gaze.

### TECHNICAL FIELD

The invention is directed to the field of head-mounted displays used notably for providing an immersive experience in virtual reality or augmented reality.

### BACKGROUND ART

High-quality head mounted displays (HMDs) like the Oculus Rift® or HTC Vive® are becoming available in the consumer market with applications ranging from gaming, film and medical usage. These displays provide an immersive experience by replacing (virtual reality) or overlaying all or part (augmented reality) the wearer's field of view with digital content. To achieve immersion at low cost, a commodity display panel is placed at short distance in front of each eye, and wide-angle optics are used to bring the image into focus.

Unfortunately, these optics distort the image seen by the wearer in multiple ways, which reduces realism and immersion and can even lead to motion sickness. While some of these distortions can be entirely handled in software, others are due to the physical properties of the lens and cannot be compensated for with software alone.

Brian Guenter, Mark Finch, Steven Drucker, Desney Tan, John Snyder, Foveated 3D graphics, ACM Transactions on Graphics (TOG), v.31 n.6, November 2012 introduced a modern adaption of foveated rendering with eye tracking, using a rasterizer, which generates three images at different sampling rates, and composites them together. While this is a good example of how performance can be saved with eye tracking, shortcomings remain, essentially in that the performance required is still too high and optical distortions are still present.

### SUMMARY OF INVENTION

### Technical Problem

The invention has for technical problem to provide a HMD that overcomes at least one of the drawbacks of the above cited prior art. More specifically, the invention has for technical problem to provide a HMD that further optimizes the computer processing of the images while still providing a good optical quality.

### Technical Solution

The invention is directed to a method for controlling images in a head mounted display HMD equipped with an eye tracker and worn by a user, comprising the following steps: detecting, with the eye-tracker, an eye gaze of at least one of the eyes of the user; controlling the images depending on the detected eye gaze; wherein the step of controlling the images comprises not rendering or not updating pixels of the images that are not visible by the user at the detected eye gaze.

According to a preferred embodiment, the pixels that are not rendered or updated comprise pixels located beyond the detected eye gaze relative to a central eye gaze when said detected eye gaze reaches one of a series of predetermined outward eye gazes.

According to a preferred embodiment, the series of predetermined outward eye gazes form a contour around the central eye gaze, said contour being circular, oval or ellipsoid.

The series of predetermined outward eye gazes and/or the corresponding contour delimit the central vision field of the user with the HMD.

According to a preferred embodiment, the pixels that are not rendered or updated comprise pixels located beyond one of a series of predetermined limits opposite to the detected eye gaze relative to a central eye gaze when said detected eye gaze reaches one of a series of predetermined outward eye gazes.

According to a preferred embodiment, the series of predetermined limits form a contour around the detected eye gaze, said contour being circular, oval or ellipsoid. The contour is specific for each predetermined outward eye gaze.

The series of predetermined limits and/or the corresponding contour delimit the peripheral vision field of the user with the HMD for a given eye gaze which is not central.

According to a preferred embodiment, the method comprises a preliminary calibration step of the series of predetermined limits opposite to the detected eye gaze relative to a central eye gaze when said detected eye gaze reaches one of a series of predetermined outward eye gazes, where a dot is displayed, as a starting position, at one of the series of predetermined outward eye gazes, to the user and moved while the user stares at said one predetermined outward eye gaze until a limit position (24.p) where said user does not see the dot anymore, the limit position and the eye gaze corresponding to said position being recorded. The dot can be any kind of dot-like reference surface, like a circle or a square.

According to a preferred embodiment, at the preliminary calibration step of the series of predetermined limits, the dot is moved in directions that are opposite to a region beyond the predetermined outward eye gaze forming the starting position.

According to a preferred embodiment, the method comprises a preliminary calibration step of the series of predetermined outward eye gazes where a dot is displayed, at a central position, to the user and moved outwardly from said central position while the user stares at said dot until an outward position where said user does not see the dot anymore, the outward position and the eye gaze corresponding to said position being recorded. The dot can be any kind of dot-like reference surface, like a circle or a square.

According to a preferred embodiment, the pixels that are not rendered or updated comprise pixels located beyond a peripheral vision contour when the detected eye gaze is central.

According to a preferred embodiment, the peripheral vision contour is defined by a series of predetermined peripheral limits.

According to a preferred embodiment, the method comprises a preliminary calibration step of the series of predetermined peripheral limits, where a dot is displayed, at a central position, to the user and moved outwardly while the user stares at said central position until an outward position where said user does not see the dot anymore, the outward position being recorded. The dot can be any kind of dot-like reference surface, like a circle or a square.

According to a preferred embodiment, at the outward and/or limit position of the dot the user indicates that he does not see said dot anymore by pressing a key.

According to a preferred embodiment, at the preliminary calibration step the dot is moved from the central and/or starting position to the outward and/or limit position in an iterative manner at different angles, so as to record several sets of eye gaze and outward and/or limit position.

According to a preferred embodiment, the method comprises using a model with the series of predetermined outward eye gazes and/or predetermined limits.

According to a preferred embodiment, the steps of detecting the eye gaze and of controlling the images are executed in an iterative manner and/or simultaneously.

The method of the invention is advantageously carried out by means of computer executable instructions.

The invention is also directed to a head mounted display to be worn by a user, comprising: a display device; at least one lens configured for converging rays emitted by the display to one eye of the user; an eye tracker; a control unit of the display device; wherein the control unit is configured for executing the method according to the invention.

According to a preferred embodiment, said head mounted display comprises a support for being mounted on the user's head and on which the display device, the at least one lens and the eye tracker are mounted.

According to a preferred embodiment, the control unit comprises a video input and a video output connected to the display device.

### Advantages of the Invention

The invention is particularly interesting in that it reduces and thereby optimizes the required computer processing for rendering the images without any impairment of the optical quality.

Virtual reality HMDs are becoming popular in the consumer space. To increase the immersion further, higher screen resolutions are needed. Even with expected progress in future Graphics Processing Units, it is challenging to render in real-time at the desired 16K HMD retina resolution. To achieve this, the HMD screen should not be treated as a regular 2D screen where each pixels is rendered at the same quality. Eye tracking in HMDs gives several hints of the user's perception. In this invention, the current visual field is used, depending on the eye gaze, to skip rendering to certain areas of the screen.

With increasing spatial and temporal resolution in head-mounted displays (HMDs), using eye trackers to adapt rendering to the user is getting important to handle the rendering workload. Besides using methods like foveated rendering, it is proposed here to use the current visual field for rendering, depending on the eye gaze. Two effects for performance optimizations can be used. First, lens defect in HMDs, where depending on the distance of the eye gaze to the centre, certain parts of the screen towards the edges are not visible anymore. Second, if the user looks up, he cannot see the lower parts of the screen anymore. For the invisible areas, rendering is skipped and the pixels colours from the previous frame are reused.

### BRIEF DESCRIPTION OF THE DRAWINGS

FIG. 1 is a schematic view of the optical principle of a HMD.

FIG. 2 corresponds to FIG. 1 where however the eye gaze oriented upwardly.

FIG. 3 illustrates an image from eye tracker provided on the HMD according to the invention.

FIG. 4 illustrates two steps of a first calibration routine of the visual field of a HMD according to the invention.

FIG. 5 illustrates the result of the visual field calibration further to the calibration steps illustrated in FIG. 4.

FIG. 6 illustrates boundary contours obtained by an interpolation of the points in FIG. 5, and an area that will not be visible by the user with an eye gaze represented by the cross;

FIG. 7 illustrates the starting point of a second calibration routine of the visual field of a HMD according to the invention;

FIG. 8 illustrates two steps of the second calibration routine;

FIG. 9 illustrates the resulting boundary contour of the second calibration routine for a given eye gaze.

### DESCRIPTION OF AN EMBODIMENT

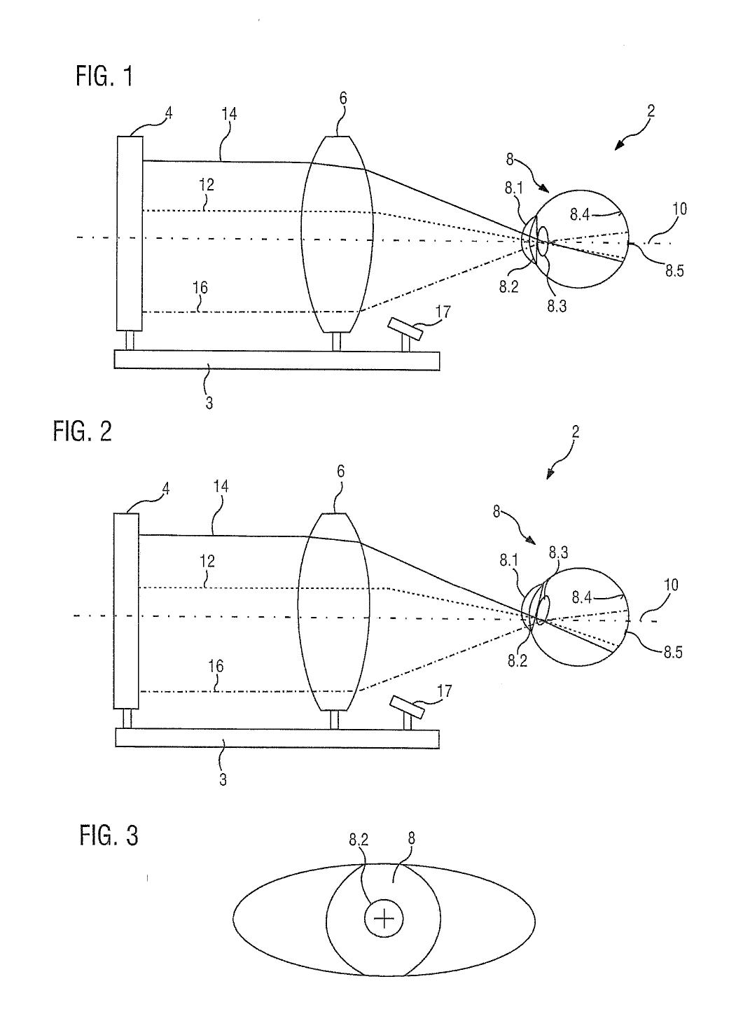

FIGS. 1 and 2 illustrate the optical principle of a HMD which can correspond to the one of the invention. The HMD 2 comprises essentially a support 3, an electronic display device 4 for displaying images, and a lens 6 arranged in front of the displaying surface of the display device 4 so as to transmit the light rays emitted by said displaying surface in a converging manner towards one of the eyes 8 of the user wearing the HMD. The display device 4 and the lens 6 are mounted on the schematically represented support 3. The lens 6 is a converging lens, advantageously with a wide angle so as to show a reduced focal length.

The eye 8 is schematically represented and generally ball-shaped. It comprises, among others, a cornea 8.1 which is transparent, a pupil 8.2 and a lens 8.3 at a front portion of the eyeball, and a retina 8.4 on a back wall of the eyeball. The size of the pupil, which controls the amount of light entering the eye, is adjusted by the iris' dilator and sphincter muscles. Light energy enters the eye through the cornea, through the pupil and then through the lens. The lens shape is changed for near focus (accommodation) and is controlled by the ciliary muscle. Photons of light falling on the light-sensitive cells of the retina 8.4 (photoreceptor cones and rods) are converted into electrical signals that are transmitted to the brain by the optic nerve and interpreted as sight and vision.

The visual system in the human brain is too slow to process information if images are slipping across the retina at more than a few degrees per second. Thus, to be able to see while moving, the brain must compensate for the motion of the head by turning the eyes. Frontal-eyed animals have a small area of the retina with very high visual acuity, the fovea centralis 8.5. It covers about 2 degrees of visual angle in people. To get a clear view of the world, the brain must turn the eyes so that the image of the object of regard falls on the fovea. Any failure to make eye movements correctly can lead to serious visual degradation.

The central retina is cone-dominated and the peripheral retina is rod-dominated. In total there are about seven million cones and a hundred million rods. At the center of the macula is the foveal pit where the cones are smallest and in a hexagonal mosaic, the most efficient and highest density. Below the pit the other retina layers are displaced, before building up along the foveal slope until the rim of the fovea 8.5 or parafovea which is the thickest portion of the retina.

In FIG. 1, the eye gaze is aligned with the optical axis 10 of the optical system formed by the display device 4 and the lens 6. A first light ray 12 is illustrated, said ray being transmitted and refracted by the lens 6 toward a focal point located at the eye's lens 8.3. That ray is then refracted by the eye's lens 8.3 and impinges on the retina 8.4. Two extreme light rays 14 and 16 are also illustrated, these rays converging also toward the eye's lens 8.3 and being refracted to impinge on the retina 8.4. We can observe that the rays 12, 14 and 16, including the extreme ones 14 and 16, hit a region of the retina that is close to the fovea 8.5, for instance aligned with the optical axis 10, meaning that the pixels of the images produced by the display device 4, even those at the upper and lower ends, can be perceived by the user.

FIG. 2 correspond to FIG. 1 where however the eye's gaze has changed, i.e. is oriented upwardly. We can observe that the light ray 12 is still refracted toward a region of the retina 8.4 that is close to the fovea 8.5 contrary to the ray 14 originating from an upper portion of the image. The light ray 16 originating from a lower portion of the image does not even impinge on the eye's lens. The pixels corresponding to these light rays 14 and 16 become therefore invisible to the user.

Lenses have a “sweet spot” where the perception of the image is best. This is usually close to the lens centre and works ideal if the eye is right in front of it. The effect is specifically noticeable in the very wide angle lenses typically used in HMDs. When the human eye looks through the centre, it can see a drawn point on the very top part of the screen. When the eye gaze is changed to look at the point high up, it is not visible anymore. By not being close enough to the “sweet spot”, the light rays of that point do not even hit the eye anymore.

The invention proposes to use eye tracking integrated into the HMD to measure the current point of gaze on the display and if the user, like in the example before, looks up, performance is improved by not rendering or not updating the pixels on those parts of the displays that are anyway not visible at that specific gaze angle. This process can be performed in real-time and therefore completely unnoticeable by the user, i.e. without loss of rendering quality or reduction in immersion. A HMD like an Oculus Rift DK2® is equipped with a customised PUPIL® head-mounted eye tracker of Pupil Labs®. To that end, an eye tracker 17 is provided on the HMD, for instance on the support 3.

FIG. 3 illustrates an eye 8 where the centre of the pupil 8.2 is detected and illustrated by a cross. The position of that centre relative to the global position of the eye indicates the eye's gaze.

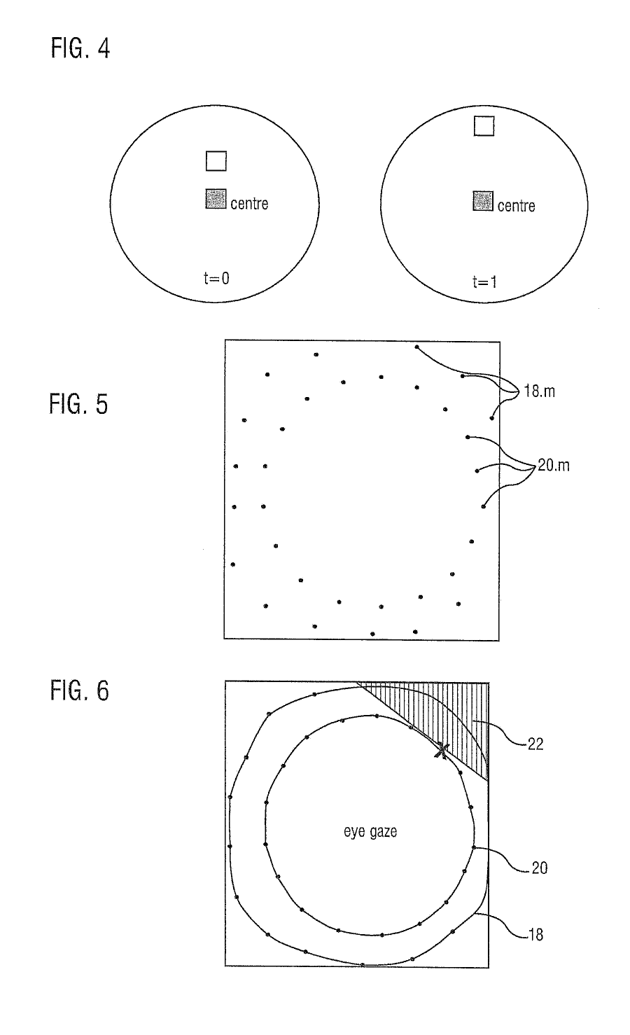

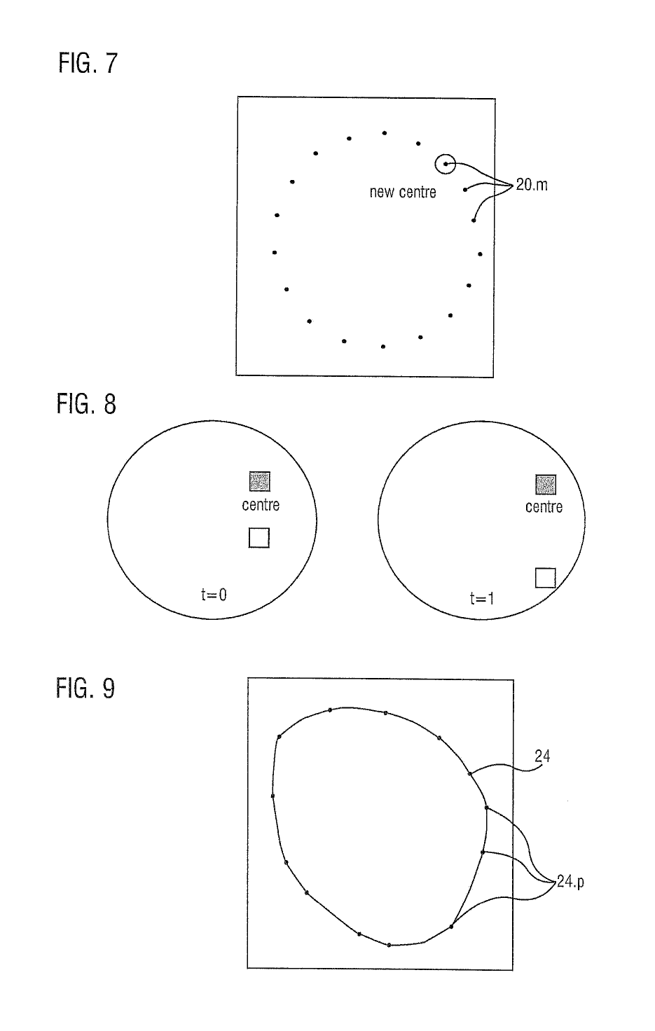

FIGS. 4 to 9 show how the eye gaze affects visibility. More specifically, FIGS. 4 to 6 illustrate a first procedure and FIGS. 7 to 9 illustrate a second procedure.

With reference to FIG. 4, a point or dot starts in the centre (t=0) and moves slowly outwards to the outer areas of the screen (t=1). Once a point disappears the user was asked to signal this, e.g. by pressing a key. This can be repeated for different angles like on a clock.

If the user looks at the centre (“sweet spot”) of the lens and does not change the eye gaze, the user can see until the points 18.m (m being an integer greater than or equal to one), in FIG. 5. A wide area of the screen is covered, corresponding to peripheral vision.

When the user follows the moving point with his eye gaze, not being in the lens “sweet spot” anymore, at the position of the points 20.n (n being an integer greater or equal to one), in FIG. 5, said points disappear out of the visual field after moving further. This corresponds to the central vision.

More specifically, in a first step, the user always looks at the centre point inside the HMD. Meanwhile, another point, e.g. blinking, will move from the centre towards the outer area of the screen and the user will press a key once the moving point is not visible anymore, resulting in the recorded points 18.m in FIG. 5. In a second step, the user always follows the moving point and presses a key once it is invisible, resulting in the recorded points 20.n in FIG. 5.

FIG. 6 illustrates the contours 18 and 20 formed by interpolation of the points 18.m and 20.n respectively. FIG. 6 illustrates also a hatched area 22 that is not visible and does not need to be rendered when the user's eye gaze is at the position on the contour 20 marked with a cross.

The proposed method will continuously analyse the gaze position and the areas described by the points on the outer and inner contours 18 and 20 in FIG. 6. If gaze is for example at the contour 20, rendering (or not updating) pixels which are beyond said contour is skipped. Optionally, with a finer granularity as well, ellipsoids can be defined as input for the eye gaze and output ellipsoids that indicated beyond which area rendering is not needed anymore.

When the user is looking at the centre, he can see more area than when directly looking into these areas, which is a lens defect in the Oculus Rift DK2® and other HMDs. This leads to a first part for a rendering optimization depending on the current visual field: if the user looks at the points on the inner contour 20 (FIG. 6), the area more outwards into that direction will not be visible at the current visual field and can be skipped for rendering. In a ray traced renderer, no primary rays would be shot for these pixels. In a rasterization setup, these pixels could be stencilled out.

FIGS. 7 to 9 illustrate a second calibration procedure, further to the first one. This second procedure is for adjusting the opposite side of the current eye gaze, e.g. if someone is looking up, he cannot see the full area on the screen below anymore. To calibrate this, the starting point for the moving dot (point, circle, rectangle, . . . ) is one of the points 20.n obtained with the first calibration procedure or on the resulting contour 20, as illustrated in FIG. 7. Advantageously, this procedure is repeated for each of the points 20.n or for several points on the corresponding contour 20.

With reference to FIG. 8, from the new centre, a dot, preferably blinking, is moved into various directions and the user has to express, e.g. by pressing a key, when it becomes invisible, so as to record a series of points beyond which the user with that specific eye gaze does not see.

FIG. 9 illustrates these points 24.p (p being an integer greater or equal to one) and a corresponding contour 24 obtained by interpolation of these points. The inner area of the contour 24 corresponds to the area that the user can see for a specific eye gaze along the contour 20 (FIG. 6), for instance for the eye gaze marked in FIG. 7. The portions of the image that are outside of that contour 24 need not therefore be rendered. As is apparent a portion of the contour 24 adjacent to the related eye gaze corresponds essentially to the corresponding portion of the contour 20 (FIG. 6) whereas the rest of said contour 24 is different. In other words, the adjacent portion delimits the direct vision of the user whereas the rest delimits the peripheral vision of said user.

As the full calibration procedure consumes much time (1-2 minutes for one clockwise calibration of 20 points), a detailed user study can develop a common model which would work well for most users with an optional individual calibration.

1-18. (canceled)

19. A method for controlling images in a head mounted display equipped with an eye tracker and worn by a user, comprising:
detecting, with the eye-tracker, an eye gaze of at least one of the eyes of the user; and
controlling the images depending on the detected eye gaze;
wherein the step of controlling the images comprises:
not rendering or not updating pixels of the images that are not visible by the user at the detected eye gaze.

20. The method according to claim 19, wherein the pixels that are not rendered or updated comprise:
pixels located beyond the detected eye gaze relative to a central eye gaze when said detected eye gaze reaches one of a series of predetermined outward eye gazes.

21. The method according to claim 20, wherein the series of predetermined outward eye gazes form a contour around the central eye gaze, said contour being circular, oval or ellipsoid.

22. The method according to claim 19, wherein the pixels that are not rendered or updated comprise:
pixels located beyond one of a series of predetermined limits opposite to the detected eye gaze relative to a central eye gaze when said detected eye gaze is not central, preferably reaches one of a series of predetermined outward eye gazes.

23. The method according to claim 22, wherein the series of predetermined limits form a contour around the detected eye gaze, said contour being oval or ellipsoid.

24. The method according to claim 22, further comprising:
a preliminary calibration step of the series of predetermined limits opposite to the detected eye gaze relative to a central eye gaze when said detected eye gaze is not central, where a dot is displayed, at a not-central starting position, preferably at one of the series of predetermined outward eye gazes, to the user and moved while the user stares at said not-central starting position until a limit position where said user does not see the dot anymore, the limit position and the eye gaze corresponding to said position being recorded.

25. The method according to claim 24, wherein at the limit position of the dot, the user indicates that he does not see said dot anymore by pressing a key.

26. The method according to claim 24, wherein at the preliminary calibration step of the series of predetermined limits, the dot is moved in directions that are opposite to a region beyond the starting position relative to the central position.

27. The method according to claim 20, further comprising:
a preliminary calibration step of the series of predetermined outward eye gazes where a dot is displayed, at a central position, to the user and moved outwardly from said central position while the user stares at said dot until an outward position where said user does not see the dot anymore, the outward position and the eye gaze corresponding to said position being recorded.

28. The method according to claim 27, wherein at the outward position of the dot, the user indicates that he does not see said dot anymore by pressing a key.

29. The method according to claim 19, wherein the pixels that are not rendered or updated comprise:
pixels located beyond a peripheral vision contour when the detected eye gaze is central.

30. The method according to claim 29, wherein the peripheral vision contour is defined by a series of predetermined peripheral limits.

31. The method according to claim 30, further comprising:
a preliminary calibration step of the series of predetermined peripheral limits, where a dot is displayed, at a central position, to the user and moved outwardly while the user stares at said central position until an outward position where said user does not see the dot anymore, the outward position being recorded.

32. The method according to claim 31, wherein at the outward position of the dot, the user indicates that he does not see said dot anymore by pressing a key.

33. The method according to claim 24, wherein at the preliminary calibration step the dot is moved from the central and/or starting position to the outward and/or limit position in an iterative manner at different angles, so as to record several sets of eye gaze and/or outward and/or limit position.

34. The method according to claim 20, further comprising:
using a model with the series of predetermined outward eye gazes and/or predetermined limits.

35. The method according to claim 19, wherein the steps of detecting the eye gaze and of controlling the images are executed in an iterative manner and/or simultaneously.

36. A head mounted display to be worn by a user, comprising:
a display device;
at least one lens configured for converging rays emitted by the display device to one eye of the user;
an eye tracker; and
a control unit of the display device;
wherein the control unit is configured for executing the following steps:
detecting, with the eye-tracker, an eye gaze of at least one of the eyes of the user; and
controlling the images depending on the detected eye gaze;
wherein the step of controlling the images comprises:
not rendering or not updating pixels of the images that are not visible by the user at the detected eye gaze.

37. The head mounted display according to claim 36, further comprising:
a support for being mounted on the user's head and on which the display device, the at least one lens and the eye tracker are mounted.

38. The head mounted display according to claim 36, wherein the control unit comprises:
a video input and a video output connected to the display device.
